(19) United States
(12) Patent Application Publication
(10) Pub. No.: US 2012/0069292 A1
(43) Pub. Date: Mar. 22, 2012

(54) Flip-up and down glasses including a spring-loaded cam-hinge mechanism

(76) Inventor: Glenn Park, Los Angeles, CA (US)

(21) Appl. No.: 12/924,068

(22) Filed: Sep. 20, 2010

(51) Int. Cl. G02C 9/02; G02C 5/22

(52) U.S. Cl. 351/48; 351/59; 351/153

(57) ABSTRACT

Flip-up and down glasses including a first frame having ear pieces for the support thereof on a wearer of the first frame and a second frame for carrying a visor or optical glasses and a flip-up and down spring-loaded cam-hinge mechanism for the second frame comprising a horizontally extending hollow sleeve, a shaft extending through the sleeve and axially secured to the first frame, a first cam having cam surfaces supported and spring-loaded for horizontal movement within the sleeve and a second cam horizontally secured on the shaft and including cam surfaces for riding on and over the cam surfaces of the horizontally moveable spring-loaded first cam to define flip-up and down positions for the second frame secured to either the second cam or to the sleeve.

### FIELD OF INVENTION

The present invention relates to flip-up and down glasses and/or visors and more particularly, to such glasses and visors including a spring-loaded cam-hinge mechanism.

### BACKGROUND OF INVENTION

Unfortunately, it seems to be a fact of life for many that age brings with it the blessing of changes in vision. For some it is a lowering of their close vision. For others, it is a lowering of far vision. With such vision changes comes the use of reading glasses and/or bi-focal or tri-focal lenses, and duplicate or special pairs of glasses for different reading and vision conditions. “Where did I leave my glasses” becomes a phrase that is uttered or mumbled or thought by many, many people. In an attempt to reduce the number of pairs of different glasses or glasses for different vision conditions, flip-up and down glasses with two frames carrying glasses with different optical characteristics or an inner frame carrying glasses of a desired optical characteristic and a second frame carrying sun glasses or a visor have been developed or proposed as evidenced by several United States patents including U.S. Pat. Nos. 3,876,295, 4,187,006, 6,939,003 and 7,018,035 which are incorporated herein by this reference. In the 3,876,295 patent, a two-part lens supporting structure is shown and described. The first part includes a pair of clips, a finger-engaging portion and a bridge clamping arm. A bridge comprises the second part and includes a rod having intermediate cam portions against which the first part is rotatably held by its clamping arm for detenting the flip-up into pre-selected positions forward of and away from the lenses of a wearer's primary glasses. In the 4,187,006 patent, a moveable frame is pivotally mounted to a fixed frame by means of grooves carried on flexible arms joined to the fixed frame to engage ribs on the moveable frame. In the 6,939,003 patent, a magnetic hinge couples a fixed frame to a rotatable frame. In the 7,018,035 patent, flip-up sunglasses are characterized by a spring-loaded hinge and a magnetic seat. In practice, such pivotal hinge connections are complex and the magnet seats are difficult to release. Accordingly, there is a continuing need for flip-up and down eyewear having an easy release and an easy movement of its movable frame toward and away from its fixed frame. The present invention satisfies those needs.

### SUMMARY OF INVENTION

The flip-up and down eye glasses of the present invention comprise a first frame having ear pieces for the support thereof on a wearer of the frame and a second frame for carrying optical glasses or a visor. Connecting the first and second frames is a flip-up and down spring-loaded cam-hinge mechanism for the second frame, including a horizontally extending hollow sleeve and a shaft extending through the sleeve and axially secured to a first frame. A first cam having horizontally extending cam surfaces is supported and spring-loaded for horizontal movement within the sleeve. A second cam is horizontally secured on the shaft and includes horizontally extending cam surfaces for riding on and over the cam surfaces of the horizontally moveable spring-loaded first cam to define flip-up and down positions for the second frame secured to the second cam or to the sleeve.

### BRIEF DESCRIPTION OF DRAWINGS

FIG. 1 is a perspective view of a first version of the flip-up and down glasses of the present invention showing a moveable frame in a down position over a fixed frame.

FIG. 2 is a second perspective view of the first version of the present invention with the moveable frame in a flip-up position and optical glasses carried in the fixed frame shown in dotted outline.

FIG. 3 is a rear view of the first version as depicted in FIG. 2.

FIG. 4 is an exploded view of the components of the spring-loaded cam-hinge included in the flip-up and down glasses of a first embodiment of the present invention.

FIGS. 5-9 each include a cut-away view of the spring-loaded cam-hinge of FIG. 4 in different corresponding rotational side-view positions of the flip-up and down glasses of the first embodiment of the invention, FIG. 5 illustrating the glasses in a down position and FIG. 9 illustrating the glasses in a fully up position.

FIGS. 10-14 each include a cut-away view of the spring-loaded cam-hinge of FIG. 4 in different corresponding rotational side-view positions of the flip-up and down glasses of the first embodiment of the invention, FIG. 10 illustrating the glasses in a fully up position and FIG. 14 illustrating the glasses in a down position.

FIG. 15 is an exploded and perspective view of the cams included in the spring-loaded cam-hinge mechanism of FIG. 4 modified to limit upward movement of the moveable frame to an angle of about 120° relative to the stationary frame in the first embodiment of the present invention.

FIGS. 16-20 each include a cut-away view of the spring-loaded cam-hinge including the cam modification of FIG. 15 in different corresponding rotational side-view positions of the flip-up and down glasses of the first embodiment of the invention, FIG. 16 illustrating the glasses in an up position of about 120° and FIG. 20 illustrating the glasses in a down position.

FIGS. 21-25 each include a cut-away view of the spring-loaded cam-hinge including the cam modification of FIG. 15 in different corresponding rotational side-view positions of the flip-up and down glasses of the first embodiment of the invention, FIG. 21 illustrating the glasses in a down position and FIG. 25 illustrating the glasses in an up position with the moveable frame of the glasses inclined about 120° to the non-moveable frame.

FIG. 26 is an exploded perspective view of a second embodiment of the flip-up and down glasses of the present invention including a clip-on moveable frame and a fixed frame.

FIG. 27 is a perspective view of the flip-up and down glasses of FIG. 26 with the clip-on moveable frame secured to the fixed frame of the second embodiment of the present invention.

FIG. 28 is a front perspective view of the flip-up and down glasses of FIG. 27 with the moveable frame in an up position.

FIGS. 29-31 each include a cut-away view of the spring-loaded cam-hinge of FIG. 28 in different corresponding side-view positions of the flip-up and down glasses of the second embodiment of the invention, FIG. 29 illustrating the glasses in a down position and FIG. 31 illustrating the glasses in a fully up position.

### DETAILED DESCRIPTION OF INVENTION

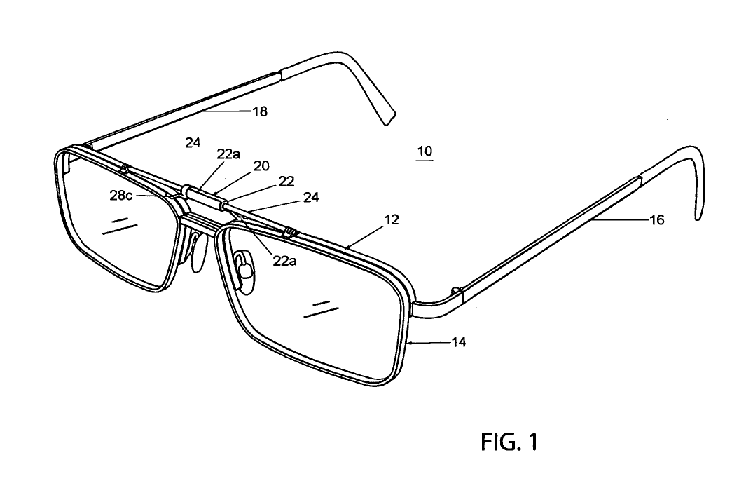

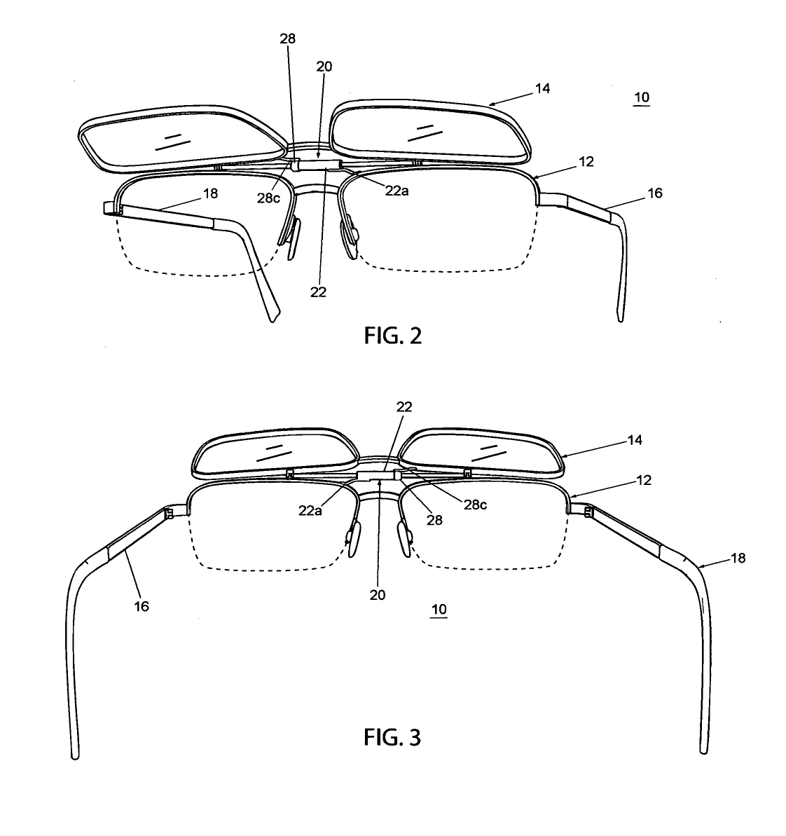

As depicted in FIGS. 1-3 a first embodiment of flip-up and down glasses 10 of the present comprises a first and second frames 12 and 14. The first frame 12 includes horizontally and rearward extending ear-pieces 16 and 18 hinged at forward ends to the first frame 12 for the support thereof on the head of a wearer of the first frame.

The second frame 14 of the flip-up and down glasses 10 of the present invention may support conventional optical glasses or a conventional visor. Therefore, it is by way of example only that only optical glasses are illustrated and described herein relative to flip-up and down glasses 10 of the present invention.

As illustrated in FIGS. 1-3, the second frame 14 is coupled for flip-up and down movement relative to the first frame 12 by a flip-up and down spring-loaded cam-hinge mechanism 20.

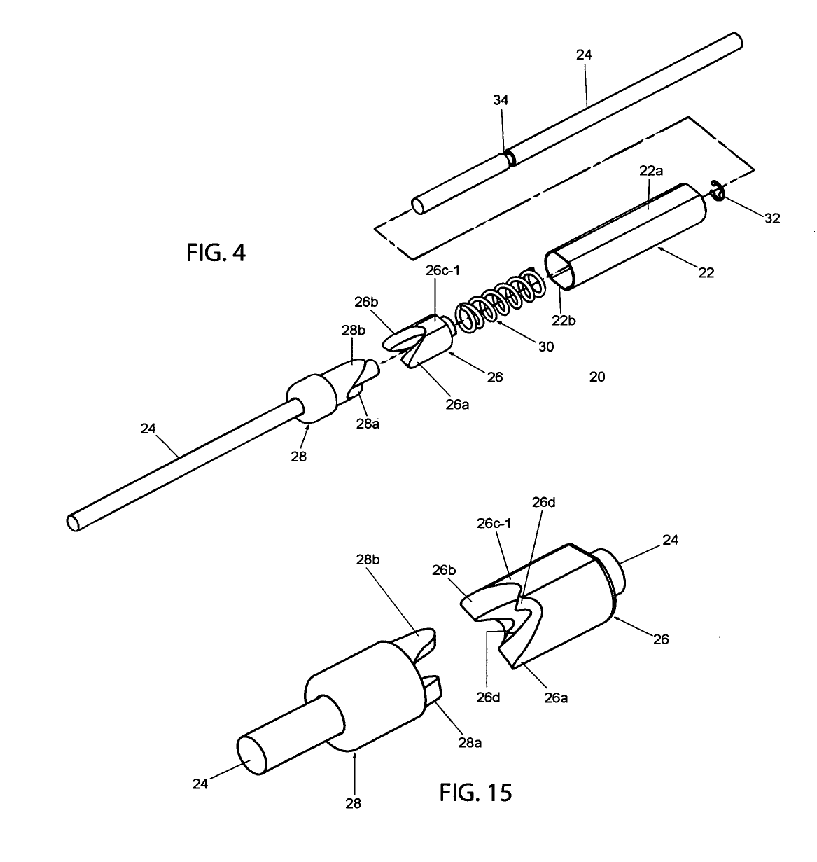

As illustrated most clearly in the exploded view thereof set forth in FIG. 4, the mechanism 20 comprises a horizontally extending hollow sleeve 22, a longitudinally and horizontally extending shaft 24, first and second horizontally extending cams 26 and 28, a horizontally extending coil spring 30 and a spring retaining clip 32 for seating in an annular groove 34 in the shaft 24. As depicted in FIGS. 1-3, the shaft 24 extends horizontally through and beyond the sleeve 22 and is axially secured at its ends to a top of the first frame 12 (e.g. by welding) as depicted in each of FIGS. 1-3.

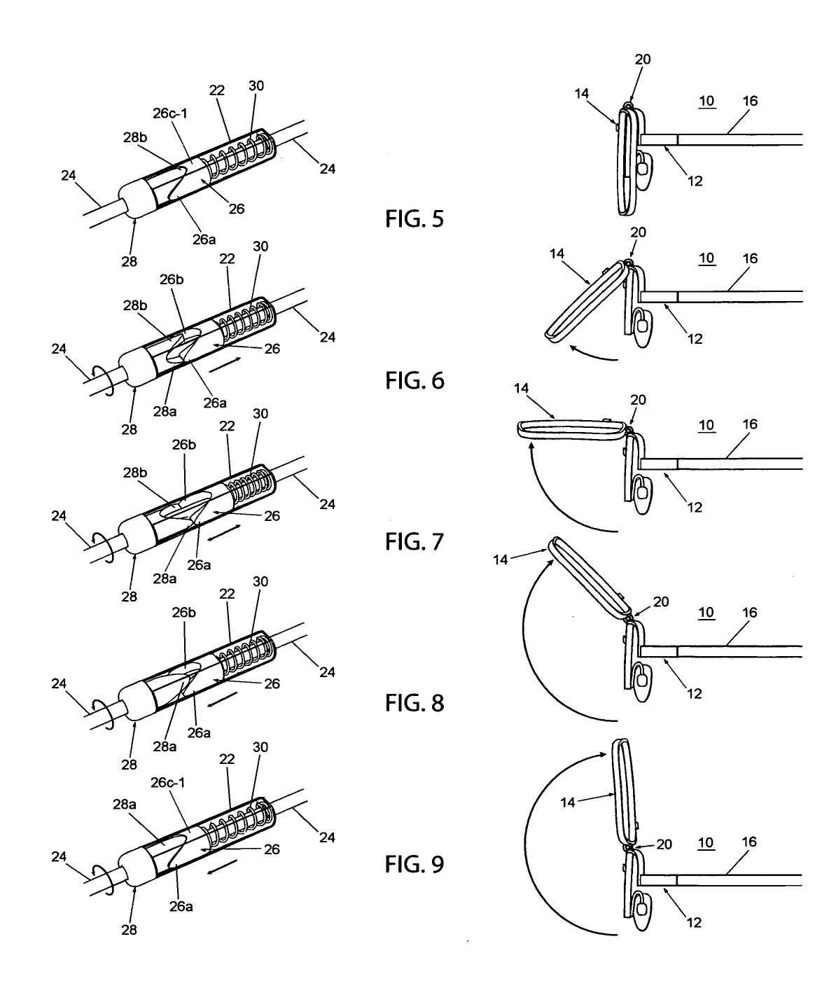

As illustrated, in FIG. 4 and in FIGS. 5-14, the first cam 26 is shaped to ride horizontally within the sleeve 22 and in the version illustrated in FIG. 4 includes two diametrically opposed horizontally-extending V-shaped cam surfaces 26a and 26b that, as illustrated in FIGS. 5-14, are supported within the sleeve 22 and spring-loaded by the spring 30 for only horizontal movement when the spring 30 is located and axially retained within the sleeve 22 by the spring clip 32 seated in the annular groove 34. Such horizontal movement for the cam 26 and the spring 30 within the sleeve 22 is further constrained by the sleeve having a flat horizontally extending top and bottom surface 22a-1 and 22a-2 and the cam 26 having a similar flat top and bottom surfaces 26c-1 (see for example FIGS. 5, 15 and 29) and 26c-2 (see FIG. 31) that engage and ride thereon as the spring 30 expands and contracts within the sleeve 22 upon the movement of the cam surfaces of the second cam 28 over the cam surfaces of the first cam 26.

In that regard, as illustrated in FIG. 4 and in FIGS. 5-14, the second cam 28 is horizontally secured on the shaft 24 and includes two diametrically opposed horizontally extending V-shaped cam surfaces 28a and 28b that are shaped to ride on and over the cam surfaces 26a and 26b of the horizontally moveable spring-loaded first cam 26 to define flip-up and down positions for the second frame 14 secured to either the second cam 28 or to the sleeve 22 in different embodiments of the present invention as hereinafter described with respect to the first and a second embodiment of the present invention.

As depicted in FIGS. 1-3, in the first embodiment of the present invention, the second cam 28 is secured by an arm 28c to the second frame 14 for rotation therewith on the fixed shaft 24 while the sleeve 22 is secured to the first frame 12 by an arm 22a to maintain it stationary on the shaft 24 during flip-up and down movement of the second frame 14 relative to the first frame 12.

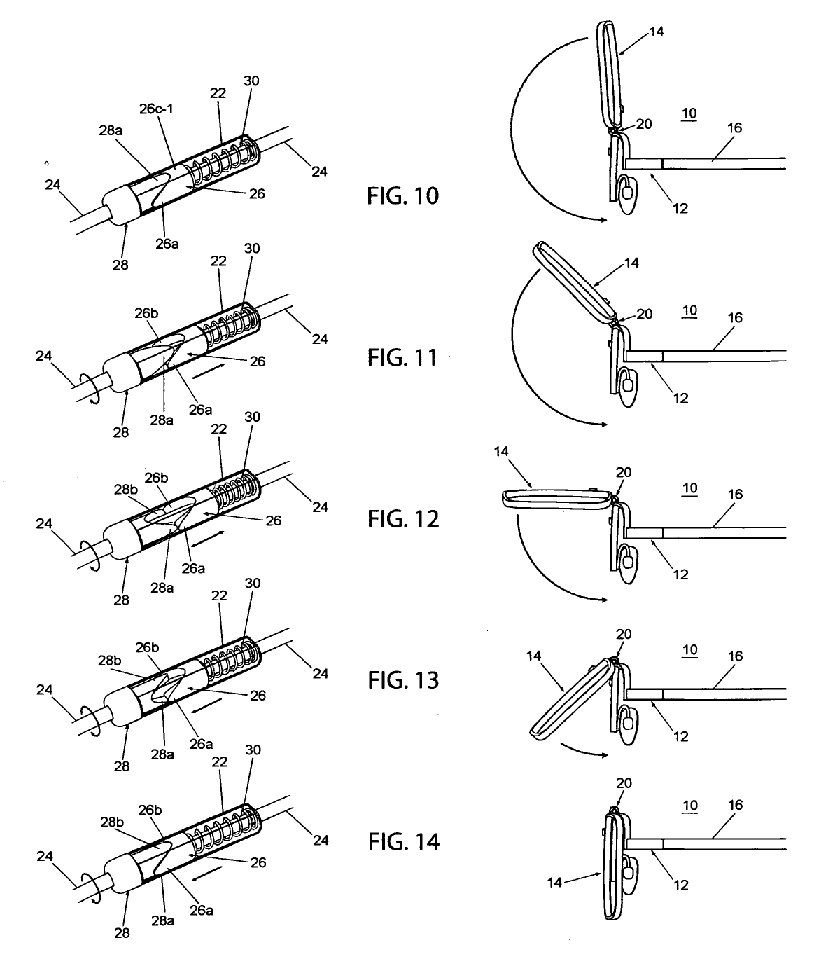

As depicted in FIG. 4 for the spring-loaded cam-hinge mechanism 20 in the first embodiment of the present invention, the horizontally extending cam surfaces 26a and 26b of the cam 26 as well as the horizontally extending cam surfaces 28a and 28b of the cam 28 are generally V-shaped and complementary of each other. Further, as illustrated in FIGS. 5-9 and FIGS. 10-14, such cam surfaces define releasable interlocking positions for the cams 26 and 28 shown in FIGS. 5 and 14 and in FIGS. 9 and 10 that respectively define down and up positions for the second frame 14 relative to the first frame 12 that are about 180° apart. Specifically, as depicted in FIGS. 5 and 14, the cam surfaces are in a down position for the frame 14 relative to the frame 12. Then, as the frame 14 is lifted slightly relative to the frame 12, as shown in FIG. 6, the cam surfaces 28a and 28b ride over the cam surfaces 26a and 26b of the cam 26 causing the cam 26 to move horizontally to the right compressing and storing energy in the spring 30 within the sleeve 22 as shown in FIG. 6 until apex portions of the V-shaped cam surfaces 28a and 28b meet the apex portions of the cam surfaces 26a and 26b as shown in FIG. 7. Further lifting of the second frame 14 produces rotation of the second cam 28 beyond the apexes of the cam surfaces of the first cam 26 allowing the spring 30 to rapidly expand and release its stored energy driving the cam 26 to the left (in FIGS. 8 and 9) and continuing the upward movement of the second frame 14 without the need of an externally applied force until the second frame 14 reaches its full “up” position as shown in FIG. 9.

When it is desired to again lower the second frame to its “down” position, the foregoing process is simply reversed by the application of a downward force to the second frame producing a movement of the cam surfaces 28a and 28b of the cam 28 over the cam surfaces 26a and 26b of the cam 26 as depicted in FIG. 11 with an accompanying movement of the cam 26 to the right within the sleeve 22 and a compression of the spring 30 storing energy therein which is released with further downward movement of the second frame 14 as depicted in FIG. 13 where the energy stored in the spring 30 is released and the second frame is driven downward to drive the cam surfaces 28a and 28b of the cam 28 over the cam surfaces 26a and 26b of the cam 26 until the cams again interlock at the full “down” position for the second frame relative to the first frame as depicted in FIG. 14.

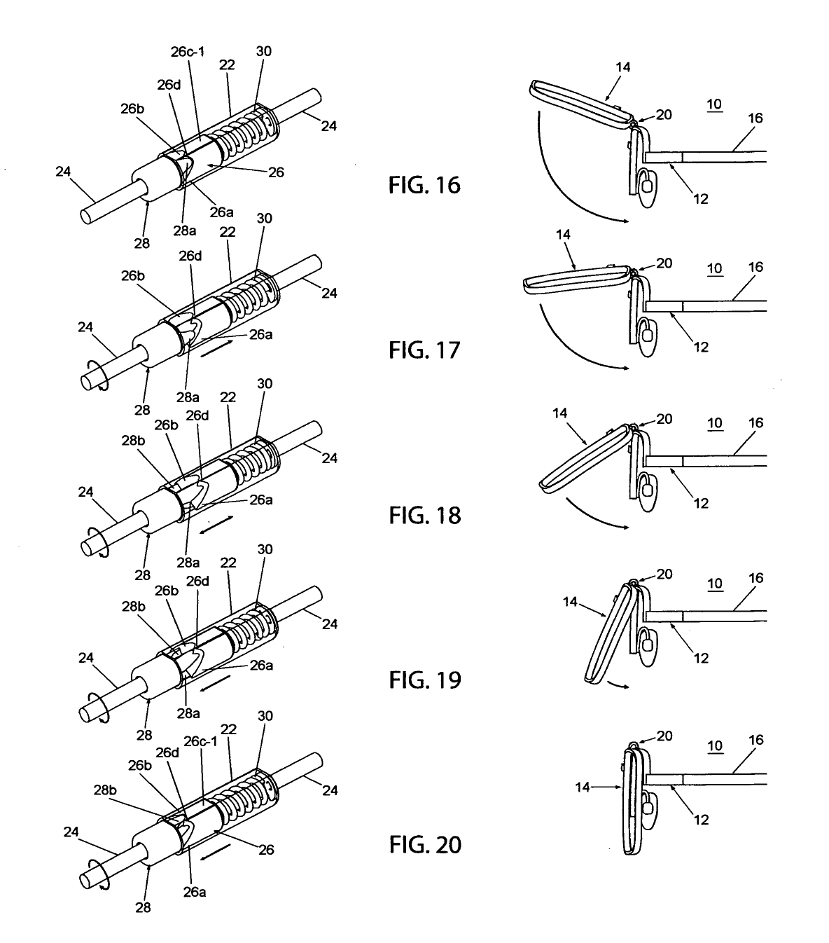

While the mating V-shaped cam surfaces of the cams 26 and 28 as depicted in FIGS. 4-14 provide a full 180° of up and down swinging movement for the second frame 14 relative to the first frame 12, if a smaller swing angle between the down position for the second frame and its up position is desired, that may be provided by a simple modification of the surfaces of the cam 26. An example of such a modification is depicted in FIG. 15 and the associated resulting reduction of the swing of the second frame is depicted in FIGS. 16-25.

As shown in FIG. 15, the cam surfaces 28a and 28b of the second cam 28 are substantially as illustrated in FIG. 4 and are structured as previously described. Alternatively, the cam 28 may be modified to resemble the cam surfaces of the modified cam 26 as depicted in FIG. 15. In this regard, as illustrated, the cam surfaces 26a and 26b of the spring-loaded horizontally moveable first cam 26 are modified by the addition of relatively small diametrically spaced and horizontally extending V-shaped cam surfaces 26d between the cam surfaces 26a and 26b. Thus constructed, and as depicted in FIG. 16, when the cam surface 28a of the cam 28 engages the cam surface 26a of the cam 26 just to the right of the cam surface 26d, the second frame 14 is in its up position relative to the frame 12 as depicted in FIG. 16. As frame 14 is moved downward as depicted in FIG. 16, the cam 28 is rotated in a clockwise direction while the cam surface 28a rides down on the cam surface 26a exerting a horizontal force on the cam 26 driving it to the right to compress the spring 30 as depicted in FIG. 17. With continued downward movement of the frame 14 as depicted in FIG. 18, the cam 28 continues to turn in a clockwise direction until the apex of the V-shaped cam surface 26a and the apex of the V-shaped cam surface 28a meet and the spring 30 is fully compressed. Further downward movement of the frame 14 relative to the frame 12 allows the spring 30 to release its stored energy driving the cam 28 in a clockwise direction with the cam surface 28b riding over the cam surface 26b as depicted in FIG. 19 until the cam surface 28b engages the left side of the cam surface 26d as depicted in FIG. 20 with the frame 14 in its full down position.

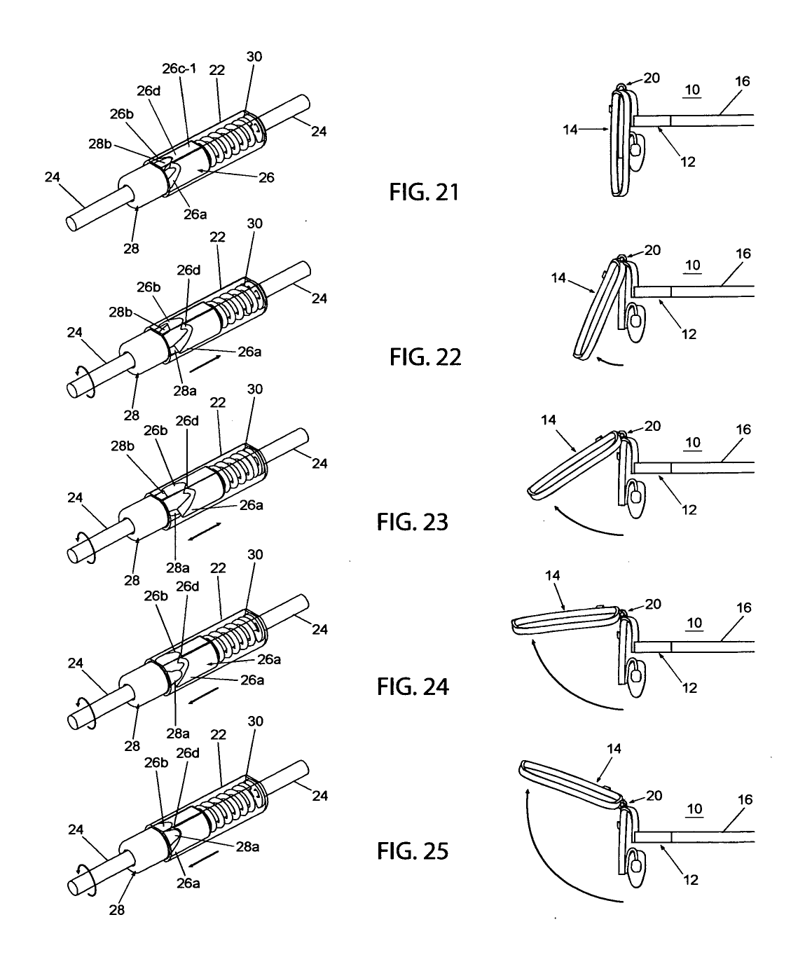

To again raise the frame 14 from its down position as depicted in FIG. 21 to its up position shown in FIG. 25, the foregoing steps are simply reversed as illustrated in FIGS. 21-25. This begins with the application of an upward force on the frame 14 and a counterclockwise turning of the cam 28 relative to the cam 26 as depicted in FIG. 22 and the beginning of the compression of the spring 30 and storage of energy therein. With continued upward movement of the frame 14 as depicted in FIG. 23, the cam 28 continues to turn in a counterclockwise direction until the apex of the V-shaped cam surface 26a and the apex of the V-shaped cam surface 28a meet and the spring 30 is fully compressed. Further upward movement of the frame 14 relative to the frame 12 allows the spring 30 to release its stored energy driving the cam 28 in a counterclockwise direction with the cam surface 28a riding over the cam surface 26a as depicted in FIG. 24 until the cam surface 28a engages the right side of the cam surface 26d as depicted in FIG. 25 with the frame 14 in its full up position displaced about 120° from the frame 12.

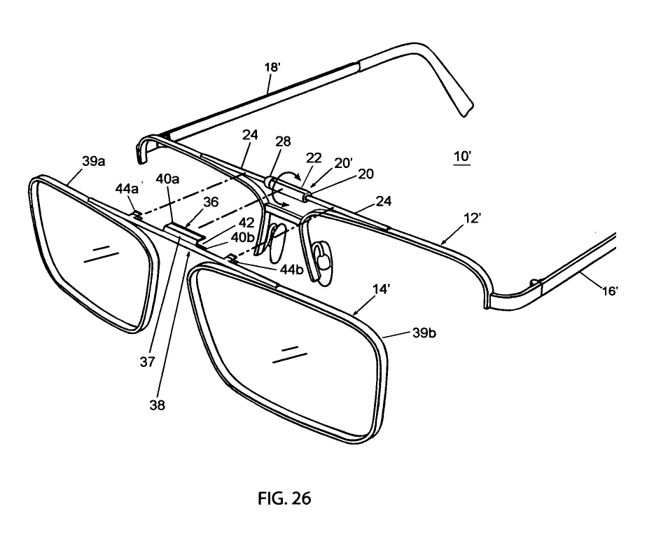

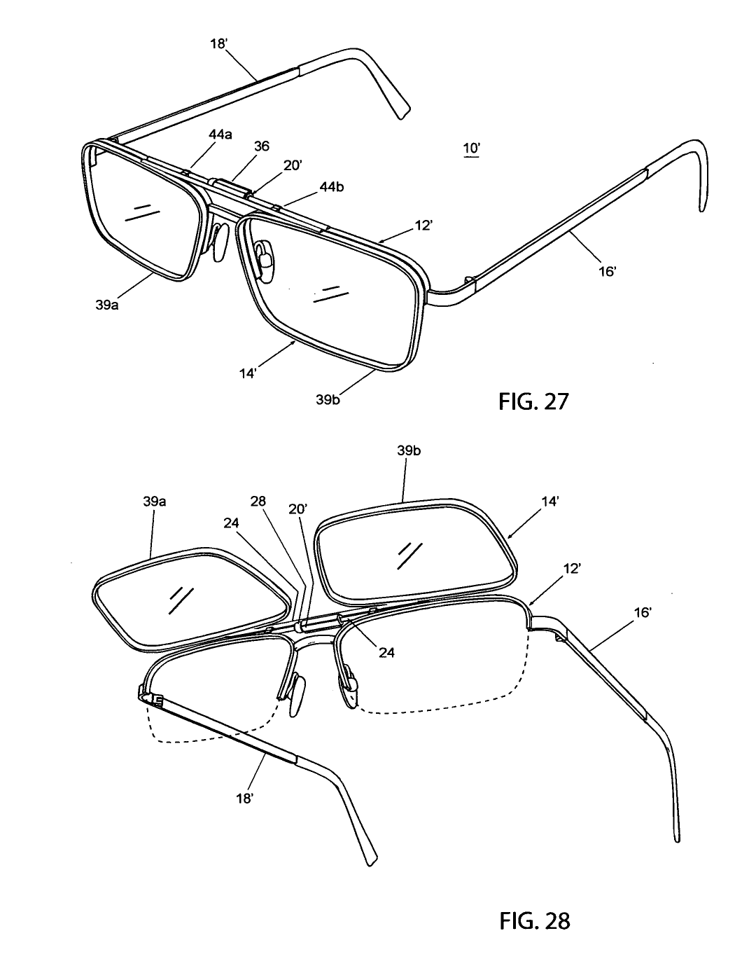

As previously indicated, FIG. 26 is an exploded view of a second embodiment of the flip-up and down glasses 10′ of the present invention including a slightly modified versions of the first frame 12′, second frame 14′ and spring-loaded cam-hinge mechanism 20′. In these regards, as depicted in FIG. 26, the glasses 10′ do not include the previously described and illustrated frame connecting arms 22a and 28c for the sleeve 22 and second cam 28, respectively. Rather, the sleeve 20 and its interior cam 26 and spring 30 are freely turnable as a unit on the shaft 24 while the second cam 28 is fixed to the shaft as by welding to prevent horizontal sliding of the sleeve on the shaft 24 as it is secured within the frame 12′. Also, as illustrated in FIGS. 26-28, the second frame 14′ is a clip-on type of frame that is releasably connectable to the first frame 12′. As depicted, such a releasable connection is primarily provided by a central horizontally extending spring clip 36 shaped to tightly receive and rotate the sleeve 20′ on the shaft 24 with up and down movement of the frame 14′ relative to frame 12′ as depicted in FIGS. 27-31.

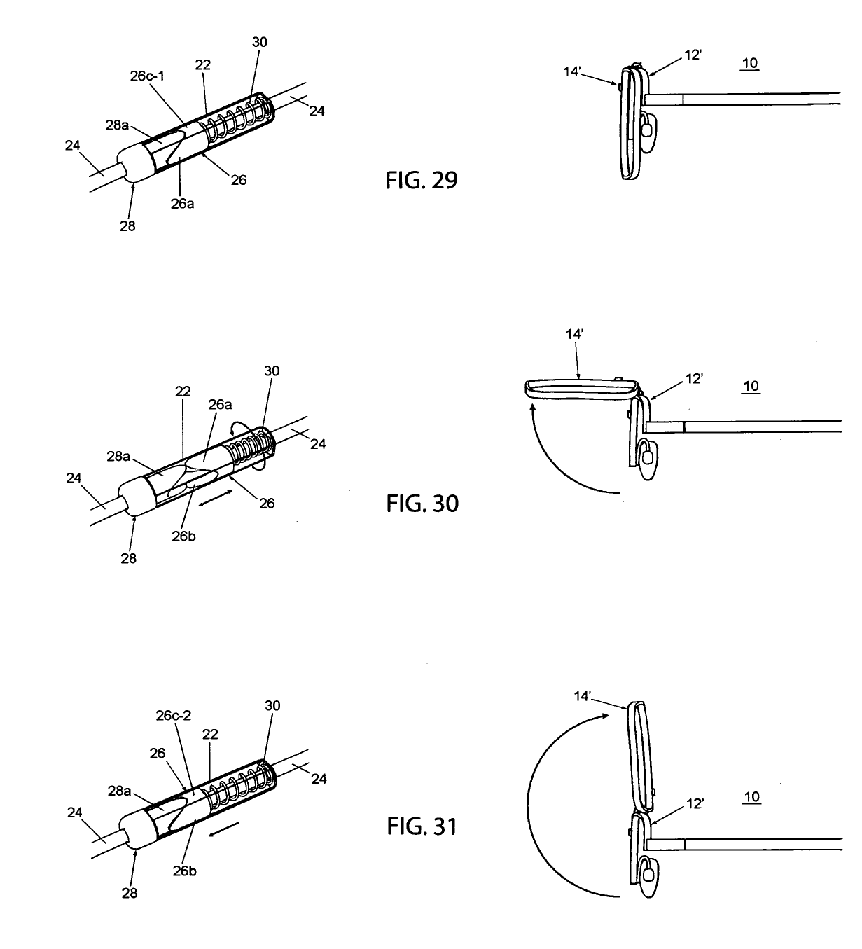

As shown in FIG. 26, the central spring clip 36 is characterized by a curved front side 37 secured, as by welding, to a horizontal top bar 38 likewise secured at its end to lens-supporting portions 39a and 39b of the second frame 14′. In addition, the spring clip 36 includes upper and lower spring arms 40a and 40b defining a horizontally extending open rear side 42 for releasably receiving the sleeve 20′ for turning on the shaft 24 with up and down movement of the frame 14′ relative to the frame 12′. Further, smaller, but similar, spring clips 44a and 44b may be releasably secured to the top bar 38 on either side of the central clip 36 to releasably receive the shaft 24 and aide in the releasable connection of the frame 14′ to the frame 12′ as depicted in FIGS. 27 and 28.

With the central spring clip 36 thus secured to the sleeve 20′ and the side spring clips 44a and 44b positioned on the shaft 24, the sleeve 20′ will turn on the shaft 24 between a down position for the frame 14′ relative to the frame 12′ as depicted in FIG. 29 to an up position for the frame 14′ relative to the frame 12′ as depicted in FIG. 31 in response to and upward lifting of the frame 14′ in a manner similar to that described relative to FIGS. 5-9 with the important exception that the cam 28 remains stationary with the cam surface 26a and 26b of the cam 26 turning with the sleeve 20 to ride over the cam surfaces 28a and 28b of the cam 28 as depicted in FIGS. 29-31.

As illustrated, in FIGS. 29-31, the first cam 26 is shaped to ride horizontally within the sleeve 22 and in the version illustrated in FIGS. 29-31 includes two diametrically opposed horizontally-extending V-shaped cam surfaces 26a and 26b that are supported within the sleeve 22 and spring-loaded by the spring 30 for horizontal movement when the spring is located and axially retained within the sleeve 22. Such horizontal movement for the cam 26 and the spring 30 within the sleeve 22 is further constrained by the sleeve having a flat horizontally extending top surface 22a and the cam 26 having a similar flat surface 26c that engages and ride thereon as the spring 30 expands and contracts within the sleeve 22 upon the movement of the cam surfaces of the cam 26 over the cam surfaces of the cam 26.

In that regard, also illustrated in FIGS. 29-31, the second cam 28 is horizontally secured on the shaft 24 and includes two diametrically opposed horizontally extending V-shaped cam surfaces 28a and 28b that are shaped to ride on and over the cam surfaces 26a and 26b of the turning and horizontally moveable spring-loaded first cam 26 to define flip-up and down positions for the second frame 14′.

As depicted in FIGS. 29-31 for the spring-loaded cam-hinge mechanism 20 in the second embodiment of the present invention, the horizontally extending cam surfaces 26a and 26b of the cam 26 as well as the horizontally extending cam surfaces 28a and 28b of the cam 28 are generally V-shaped and complementary of each other. Further, as illustrated such cam surfaces define releasable interlocking positions for the cams 26 and 28 shown in FIGS. 29 and 31 that respectively define down and up positions for the second frame 14′ relative to the first frame 12′ that are about 180° apart. Specifically, as depicted in FIG. 29, the cam surfaces are in a down position for the frame 14′ relative to the frame 12′. Then, as the frame 14′ is lifted slightly relative to the frame 12′, as shown in FIG. 30, the cam surfaces 26a and 26b ride over the stationary cam surfaces 28a and 28b of the cam 28 causing the cam 26 to move horizontally to the right compressing and storing energy in the spring 30 within the sleeve 22 as shown in FIG. 30 until apex portions of the V-shaped cam surfaces 26a and 26b meet the apex portions of the cam surfaces 28a and 28b. Further lifting of the second frame 14′ produces rotation of the cam 26 beyond the apexes of the cam surfaces of the first cam 28 allowing the spring 30 to rapidly expand and release its stored energy driving the cam 26 to the left (in FIG. 31) and continuing the upward movement of the second frame 14′ without the need of an externally applied force until the second frame 14′ reaches its full “up” position.

As previously described relative to FIGS. 10-14 for the first embodiment of the present invention, when it desired to again return the second frame 14′ to its down position, the foregoing procedure is simply reversed to again store energy in the spring 30 upon a lowering of the frame 14′ followed by a release of the stored energy to complete the downward movement of the frame 14′ to its down position.

While specific embodiments of the present invention have been described and illustrated herein, it is to be appreciated that changes may be made in those embodiments without departing from the spirit of the present invention. Therefore, the present invention is to be limited in scope only by the terms of the following claims.

1. Flip-up and down glasses comprising:
a first frame having ear pieces for the support thereof on a wearer of the first frame;
a second frame for carrying optical glasses or a visor; and
a flip-up and down spring-loaded cam-hinge mechanism for the second frame, including
a horizontally extending hollow sleeve,
a shaft extending through the sleeve and axially secured to a first frame,
a first cam having horizontally-extending cam surfaces supported and spring-loaded for horizontal movement within the sleeve; and
a second cam horizontally secured on the shaft and including horizontally-extending cam surfaces for riding on and over the cam surfaces of the horizontally moveable spring-loaded first cam to define flip-up and down positions for the second frame secured to either the second cam or to the sleeve.

2. The flip-up and down glasses of claim 1 wherein the first cam and the sleeve include engaging horizontal surfaces.

3. The flip-up and down glasses of claim 1 wherein the second cam is connected to the second frame and is turnable on the shaft relative to the first cam with flip-up and down movement of the second frame.

4. The flip-up and down glasses of claim 1 wherein the sleeve is connectable to the second frame and the sleeve and the second cam are turnable on the shaft relative to the second cam with flip-up and down movement of the second frame.

5. The flip-up and down glasses of claim 4 wherein the second frame includes a horizontally extending cross-bar and a rearward facing clip extending from the cross-bar to engage and releasably secure the second frame to the sleeve to turn the sleeve and the spring-loaded second cam on the shaft with flip-up and down movement of the second frame.

6. A spring-loaded cam-hinge mechanism for flip-up and down visors and eye glass frames, comprising:
a horizontally extending hollow sleeve;
a shaft extending through the sleeve and axially secured to a first frame having ear pieces for the support thereof on a wearer of the first frame;
a first cam having horizontally-extending cam surfaces supported and spring-loaded for horizontal movement within the sleeve; and
a second cam horizontally secured on the shaft and including horizontally-extending cam surfaces for riding on and over the cam surfaces of the horizontally moveable spring-loaded first cam to drive the spring-loaded cam within the sleeve to store energy therein and define flip-up and down positions for a second frame secured to either the second cam or to the sleeve.

7. The spring-loaded hinge mechanism of claim 6 wherein the second cam is connected to the second frame and is turnable on the shaft relative to the first cam with flip-up and down movement of the second frame.

8. The spring-loaded hinge mechanism of claim 6 wherein the sleeve is connectable to the second frame and the sleeve and the second cam are turnable on the shaft relative to the first cam with flip-up and down movement of the second frame.

9. The spring-loaded hinge mechanism of claim 6 wherein the spring loading of the first cam is provided by a horizontally extending spring within the sleeve.

10. The spring-loaded hinge mechanism of claim 6 wherein the horizontally extending cam surfaces of the first and second cams are V-shaped to ride over each other upon a turning of one of the cams relative to the other.

11. The spring-loaded hinge mechanism of claim 10 wherein the V-shaped cam surfaces include secondary cams surfaces there-between defining different stop positions for the cams.
